(19) United States
(12) Patent Application Publication
(10) Pub. No.: US 2023/0075424 A1
(43) Pub. Date: Mar. 9, 2023

(54) DECISION TREE PROCESSING SYSTEM

(71) Applicant: Seagate Technology LLC, Fremont, CA (US)

(72) Inventors: Rishi Ahuja, Broomfield, CO (US); Zheng Wang, Louisville, CO (US)

(21) Appl. No.: 17/469,471

(22) Filed: Sep. 8, 2021

(51) Int. Cl. G06N 5/00; G06N 20/20

(52) U.S. Cl. CPC G06N 5/003; G06N 20/20

(57) ABSTRACT

Systems and methods are disclosed for a decision tree processing system. A machine learning decision tree architecture, such as a Random Forest, can be very intense in computation and can require a large amount of memory. To account for such, the systems and methods herein can implement a hardware approach where the training for the decision trees can be performed in advance via firmware (or an algorithm implemented via any other software and processing system) and the hardware can implement a circuit to process the decision trees. In some examples, multiple decision trees may be processed in parallel. Also, a circuit can compute the best outcome for a decision tree based on a random feature and a pre-determined threshold for the random feature assigned to each node of the decision tree.

### SUMMARY

In certain embodiments, an apparatus may comprise a circuit for processing a multiple decision tree architecture, the circuit couplable to a memory and configured to determine a first result from processing a first node of a first decision tree of the multiple decision tree architecture based on a node value from the memory and a feature threshold, and compute an address of a second node of the first decision tree based on the first result, a current node address, and a number of nodes in a level of the decision tree to which the current node address belongs.

In certain embodiments, a circuit may comprise a memory storing data representing node values of a decision tree, and a comparator circuit configured to receive data, from the memory, for a selected node of the decision tree and receive a threshold, and compare the data and the threshold to determine an output. The circuit may also comprise an adder circuit configured to receive the output, a current node address, and a number of nodes at a current depth level of the decision tree, and calculate a next node address based on the output, the current node address, and the number of nodes at the current depth level, where the next node address is a next selected node to be processed by the comparator circuit.

In certain embodiments, a method may comprise processing, via a comparator circuit, a first node of a selected level of a Random Forest architecture having a decision tree with multiple levels, the comparator circuit configured to produce a first decision. The method may also comprise calculating, via an adder circuit, an address of a second node at a next level of the decision tree based on the first decision, the first node’s address, and a number of nodes at the selected level. The method may repeat the processing and the calculating for each of the multiple levels of the decision tree before reaching a last level of the decision tree, and obtain an output of the decision tree based on an address of a last node in the last level that was calculated via the adder circuit.

### BRIEF DESCRIPTION OF THE DRAWINGS

FIG. 1 is a diagram of a decision tree processing system, in accordance with certain embodiments of the present disclosure;

FIG. 2 is a diagram of a decision tree processing system, in accordance with certain embodiments of the present disclosure;

FIG. 3 is a diagram of a decision tree processing system, in accordance with certain embodiments of the present disclosure;

FIG. 4A is a diagram of a decision tree processing system, in accordance with certain embodiments of the present disclosure;

FIG. 4B is a lookup table for use in a decision tree processing system, in accordance with certain embodiments of the present disclosure;

FIG. 5 is a diagram of a process for a decision tree processing system, in accordance with certain embodiments of the present disclosure; and

FIG. 6 is a diagram of a decision tree processing system, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, logic gates, discrete electronics, system-on-chip (SoC), and other hardware devices can likewise be constructed to implement the circuits, functions, processes, and methods described herein. Methods and functions may be performed by modules or engines, both of which may include one or more physical components of a computing device (e.g., logic, circuits, processors, controllers, etc.) configured to perform a particular task or job, may include instructions (e.g., firmware or other software) that, when executed, can cause a processor to perform a particular task or job, or may be any combination thereof. Further, the methods, functions, and processes described herein may be implemented as a computer readable storage medium or memory device including instructions (e.g., firmware or other software) that, when executed, cause a processor to perform the methods.

While part of the discussion herein is provided with respect to data storage, one skilled in the art will recognize that the technologies and solutions disclosed are applicable to any system that can implement decision trees, such as a Random Forest architecture or similar decision tree system. For example, Random Forest is a class of machine learning algorithm which relies on an ensemble of multiple data decision trees merged together to get an accurate and stable prediction. In order to get the Random Forest algorithm not biased, each tree can be trained on a large amount of datasets, which makes the Random Forest algorithm very complex to implement and can require a large amount of computational resources. One of the main advantages of the Random Forest algorithm is that it can be used for both classification and regression problems. Thus, the disclosure herein presents improvements and solutions for decision tree processing systems that require large computational complexity and computational resource requirements to be implemented.

For example, this disclosure presents a solution that includes a circuit (e.g., an Application Specific Integrated Circuit (“ASIC”)) that is configured to implement a decision tree processing system, such as a Random Forest, which in some embodiments may be used for data storage applications (e.g., solid state drives (“SSD”) or hard disc drives (“HDD”)). Such circuit may be implemented in an SoC; further, each SoC may be independently tuned based on various categorical and numerical features like temperature, process, operating voltage, frequency, bit error rate, etc. The solutions provided herein include a very low complexity, high throughput hardware circuit design for implementing a decision tree machine learning algorithm.

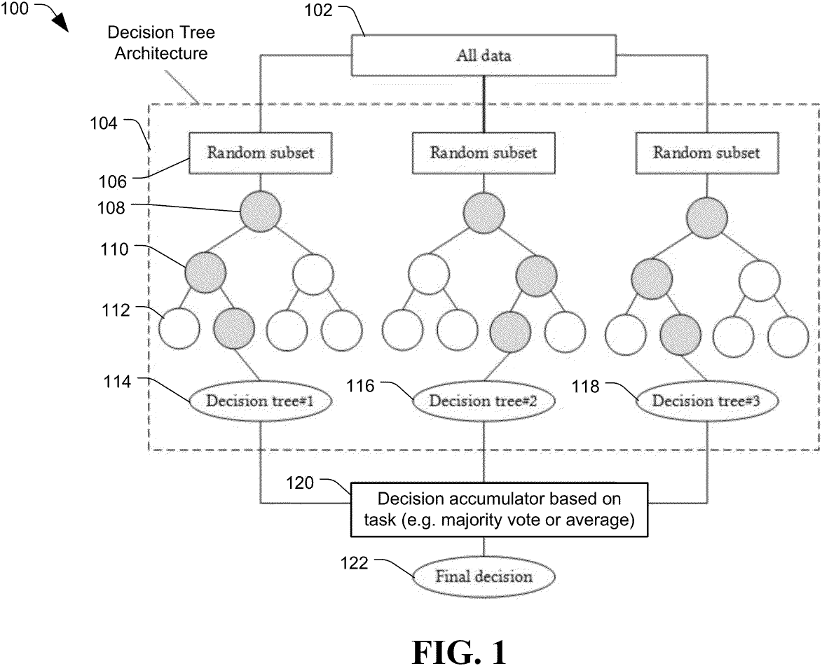

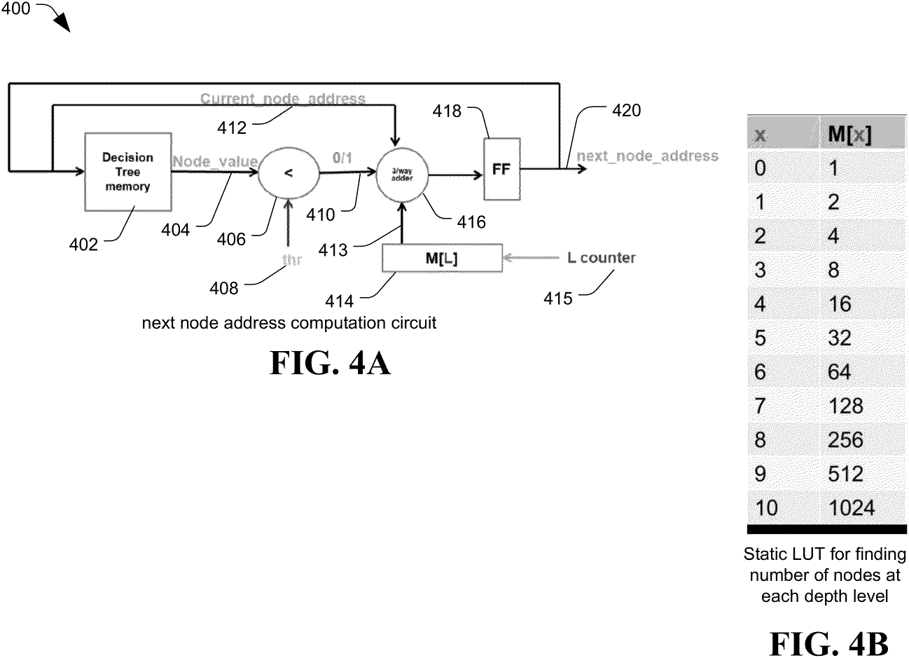

FIG. 1 shows a diagram of a process for a decision tree processing system, generally designated 100, in accordance with certain embodiments of the present disclosure. Process 100 may be implemented by the circuits and other hardware discussed herein; for example, process 100 may be implemented via, at least in part, circuit 400 shown in FIG. 4A, which in some embodiments, may be utilized to process a Random Forest algorithm.

In some embodiments, Random Forest is a type of supervised machine learning algorithm which works by combining different decision trees. For example, FIG. 1 shows three different decisions trees 104. Instead of searching for the most important feature while splitting a decision tree node (e.g., node 108, node 110, or node 112), a Random Forest algorithm can search for the best feature among a random subset 106 of the training data 102. The algorithm can use a random threshold for each feature.

In some embodiments, each decision tree 104 can be trained individually. The training data set for each tree can come from a subset 106 of the original training data set 102, which may be random. Each node of each tree consists of a feature (also referred to as a parameter) and a threshold. The feature and the corresponding threshold can be determined during a training process. For example, the training process can be a brute force process where at each node, a subset of features is tested with various threshold values to split the training data. The feature and threshold that optimize the criterion/metric can be eventually chosen for that node.

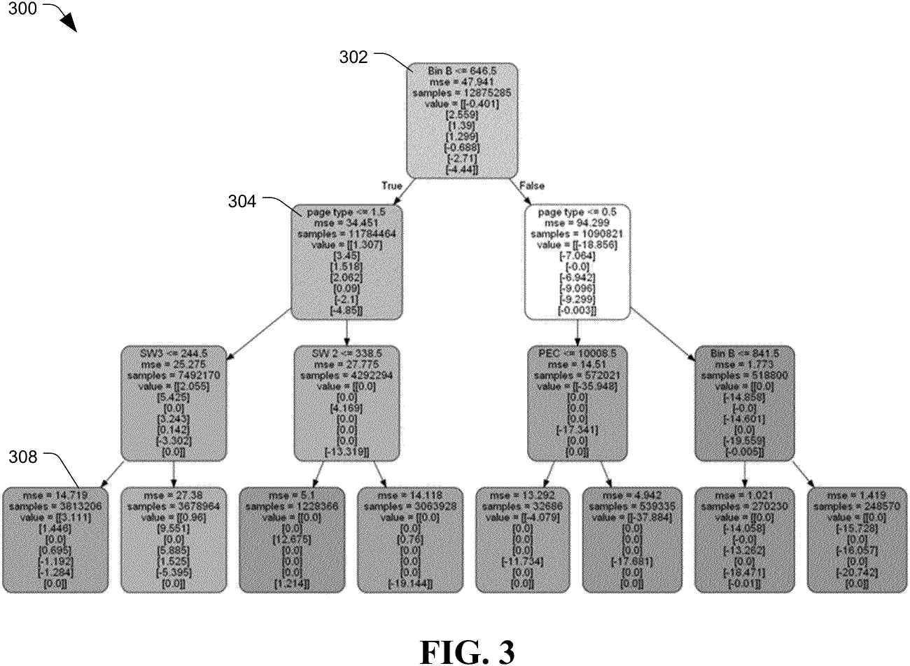

In some embodiments, the original training data sets 102 can be randomly sampled and passed onto different decision trees, such as at 106, to decrease the correlation between the trees, where the feature data sets can be selected based on bootstrap aggregating, bagging, or another selection methodology. The system 100 can utilize the outcome of the decision trees (e.g., outcome 114, outcome 116, and outcome 118), at 120, to determine a decision for a task to arrive at a final decision 122. A data sample, which can consist of multiple feature values (such as shown in FIG. 3), can traverse each individual decision tree by comparing the corresponding feature value with the threshold value at each node. The leaf node (which are the nodes at the last level of each decision tree) the processing eventually reaches is the decision from that particular tree. Based on the decision from each tree (e.g., decision 114, 116, and 118), the system 100 may determine a final decision 122. For example, for a classification task, the accumulator 120 may utilize a majority vote determination to select the final decision 122 by counting the decision from each tree and determining what decision option has the most votes; in another example, for a regression task, the accumulator 120 may implement an average computation determination to compute the final decision 122 by utilizing the values of each decision from each tree. Further, to reduce impurity, each decision tree can be trained and results stored as scaled values based on the importance of the feature.

Generally, a Random Forest algorithm can be very intense in computation and require a large amount of memory, both for a training phase for each decision tree and then for computing the final outcome of the decision trees. To solve these problems, a solution is provided herein to implement the decision tree architecture 104 as a joint software (e.g., firmware) and hardware approach where the training for the decision trees can be performed via software by sampling a very large data set, and the trained values (e.g., including the features and the corresponding threshold values for all the nodes) of such decision trees can be programmed to a memory of a hardware processing system for the processing of the decision trees. The hardware processing system can implement the decision trees, such as in parallel, and may compute the best outcome for each tree based on a threshold for each feature. Example implementations of such solutions are provided herein.

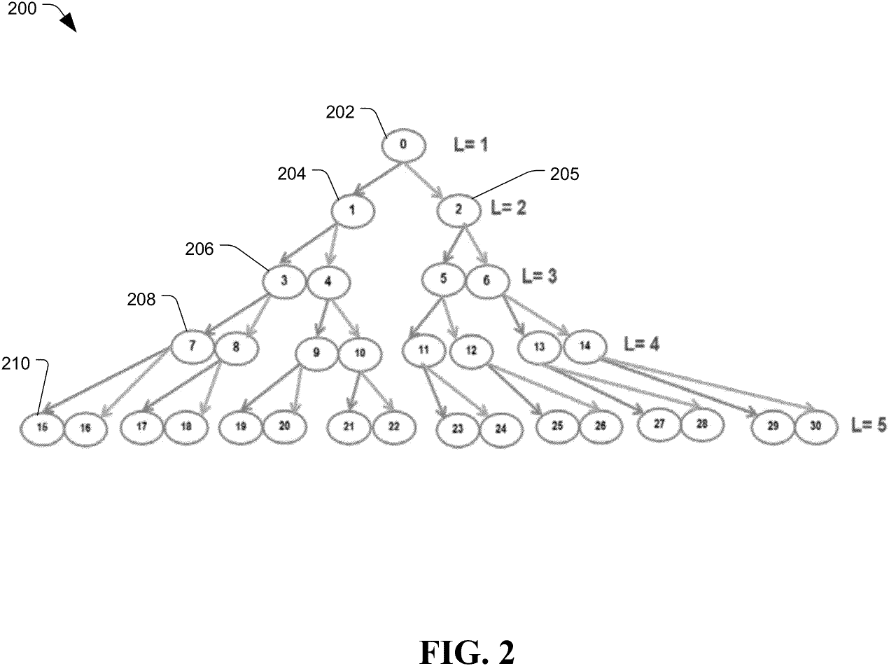

FIG. 2 shows a diagram of a system of a decision tree processing system 200, in accordance with certain embodiments of the present disclosure. Further, FIG. 2 shows an example of a machine learning decision tree, such as one of decision trees 104 of FIG. 1, which can be processed through or searched via circuit 400 of FIG. 4A.

The hardware of circuit 400 can have a very low complexity and allow for searching quickly through decision tree 200 by calculating the address for a next leaf node based on a current node address. Further, the circuit 400 can be processed through at a same number of clock cycles as the depth of the decision tree. The circuit 400 may utilize a static lookup table (“LUT”), such as shown in FIG. 4B, to find a number of leaf nodes at each level of the decision tree. As discussed above, multiple decision trees may be implemented to be processed, which may be done in parallel with multiple versions of the circuit 400. For example, a number of decision trees may be selected based on the requirements of the system and data set for which the decision tree processing system is implemented.

In a specific example, FIG. 2 shows an example decision tree with depth of five (5) levels. All node values (e.g., including the features and the corresponding threshold values for all the nodes) can be stored in a decision tree memory, such as nonvolatile solid-state memory accessible via an interface (e.g., hardware, firmware, or a combination thereof). The values shown in each node of FIG. 2 (e.g., nodes 202, 204, 206, 208, and 210) represent the node address in the decision tree memory.

During operation, the processing circuit can start from the root node 202 stored at address 0 in the decision tree memory, and compute the address of the next node 204 in the decision tree memory by using a feature threshold. For example, if the value of the current node (accessed using the current node address) is less than or equal to the feature threshold, the left branch is taken (e.g., to node 204), and if the value is greater than the programmed threshold the right branch (e.g., to node 205) is taken. The next node address can then be calculated based on the current node decision, as discussed herein.

In some embodiments, the next node address in the decision tree memory can be computed by using the following equation:

$$\text{NNA=M} \left[\text{L}\right] \text{-1+2*} \left(\text{CNA-} \left(\text{M} \left[\text{L-1}\right] \text{-1}\right)\right) \text{+DET} \left(\text{thr}\right)$$

Where ‘NNA’ is the next node address, ‘M’ is a static LUT used for representing a number of nodes in each level of the decision tree, and ‘CNA’ is the current node address. The input to the LUT is ‘L’ a level counter (counter size is as per number of levels) used for counting the depth (level) of the decision tree. A current value of the counter ‘L’ represents the active depth level in progress while processing the decision tree. Further, DET(thr) represents the determination made at the current node based on the threshold (thr), which results in adding in the equation either a zero (0) when the left branch is taken or a one (1) when the right branch is taken. In some embodiments, a decision tree could be constructed that allows for some determinations to be skipped if the trained data indicates one of the paths would never be taken (e.g., if a node value was such a value as compared to a threshold that is would never allow for one of the paths to be selected in a binary determination).

This allows for a simplified decision tree processing system to be implemented that eliminates the need of storing the history of all the paths and, thus, can have a high throughput (comparably to Random Forest systems that require the history of all paths). The next node address can simply be computed by accessing the value of the decision tree based on the current node address and the comparison with the feature threshold. This architecture will require only a minimum amount of memory to store the various decision tree values. The architecture also requires only one comparison operation per level and it is not dependent on the number of nodes at each level.

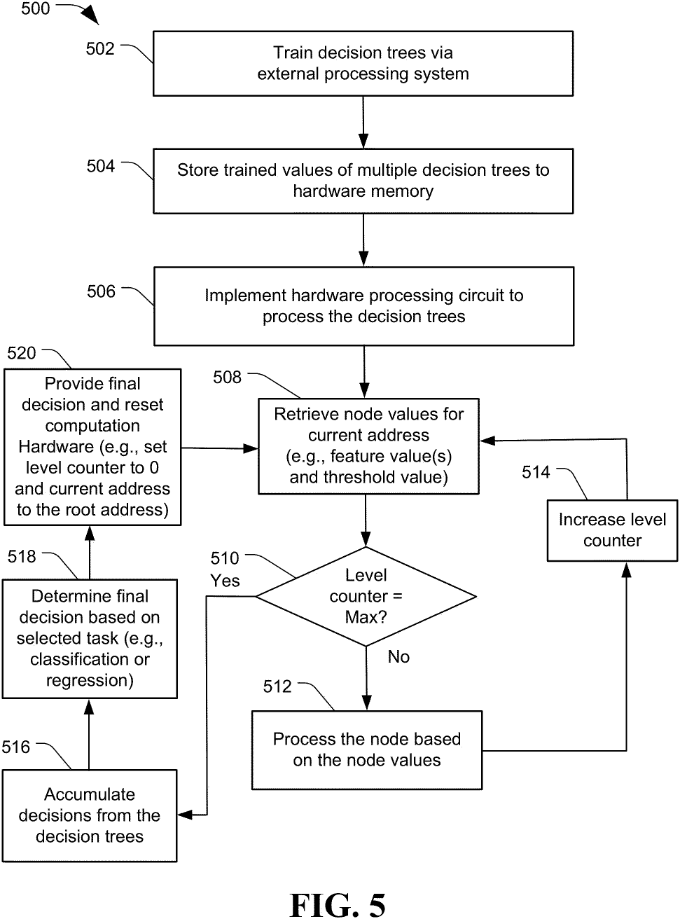

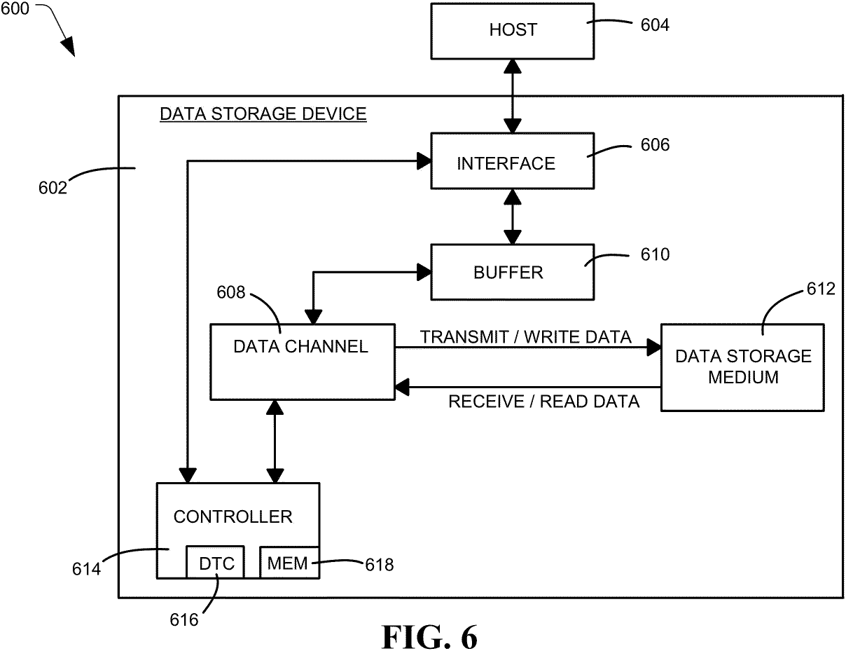

FIG. 3 shows a diagram of a system of a decision tree processing system 300, in accordance with certain embodiments of the present disclosure. Further, FIG. 3 shows an example of a machine learning decision tree, such as one of decision trees 104 of FIG. 1, or decision tree 200 of FIG. 2, which can be processed through or searched via circuit 400 of FIG. 4A or the process 500 of FIG. 5. FIG. 3 may be a decision tree utilized with a data storage device, such as device 602 in FIG. 6, and in particular may be utilized with a solid state data storage device (SSD).

The example decision tree 300 shown includes four depth levels to propagate to arrive at a decision. Each depth level includes one or more nodes, such as node 302, 304, 306, and 308, that have node values associated with the specific node. The node values can be stored in a memory and can include a subset of the trained feature values, a threshold value corresponding to the node, and other information. The threshold value may correspond to a particular parameter assigned to the specific node, such as shown in the first line of each of the nodes in FIG. 3. For example, “Bin B <= 646.6” shown for node 302 indicates that the parameter to be evaluated for node 302 is “Bin B” and the related threshold is “646.6”, whereas for node 304 the parameter to be evaluated is “page type” and the corresponding threshold is “1.5”. Each node may have a different parameter, threshold, or both; however, it is not required that all nodes have different parameters and thresholds.

While propagating the decision tree 300, the nodes can be processed as described herein. For example, for the root node 302, if the “Bin B” value is less than or equal to the corresponding threshold, the node value is determined to be true (left branch, “0” for DET(thr) in the equation above) and the decision tree would then process node 304. If a node parameter comparison was determined to be false, the node propagation would take the false route (right branch, “1” for DET(thr) in the equation above). An address of a next node to process can be quickly calculated by circuit 400 or process 500.

Once the processing has reached one of the nodes in the last level of the decision tree, such as node 308, which may be referred to as a leaf node, the value(s) associated with that leaf node is the decision of that decision tree. For example, for node 308, the value is “[ [3.111] [1.446] [0.0] [0.695] [-1.192] [-1.284] [0.0]”. This example estimates the value of a vector of length seven, which is why each node shows seven values. The estimation (vector) at the decision node can be combined (either in average or majority vote or other methods) with decision from other decision trees in the forest, to give a final result.

FIG. 4A shows a diagram of a system 400 of a Random Forest architecture, in accordance with certain embodiments of the present disclosure. The system 400 may be a circuit, such as an ASIC or SoC or other circuit, configured to process through a decision tree architecture, such as shown in FIG. 1, FIG. 2, and FIG. 3.

In some embodiments, the system 400 can include an electronic hardware circuit that implements the above equation to compute a next node address. The system 400 can include a memory 402, a comparator 406, an input to the comparator 406 for a threshold 408, a three-way (3-way) adder 416, a LUT 414, a counter 415, a flip flop (FF) 418, and a next node address output 420.

During operation of the system 400, the next node address can be computed by accessing, via the memory 402, the value of the decision tree based on the current node address (Node_value 404), and comparing it with a feature threshold 408 (which may also be retrieved from a memory location corresponding to the current node address) using a comparator 406. A size of the comparator can depend on the maximum threshold values and the maximum decision tree values. The result (0 or 1) 410 of the comparator 406, along with current node address 412, and number of nodes in the current level 413 can be added via the 3-way adder 416 to compute the next node address 420, which may be stored in FF 418 that can act as a memory element to store the corresponding address pointer. The number of nodes in the current level 413 can be obtained from the LUT 414 using level counter ‘L’ 415 as an index. An example LUT 414 is shown in FIG. 4B.

Once the next node address is computed, the current level counter ‘L’ is also increased by 1 to point to the next active level (depth of the decision tree). The next node address can be retrieved from the memory 402 and the system 400 can process the next level of the decision tree until a final decision has been reached. A final decision may be reached when the decision tree processes all its levels and arrives at a specific leaf node, where the value(s) of the specific leaf node are the decision for the respective decision tree. The system 400 can be reset once the level counter ‘L’ is greater than the total number of levels in the decision tree (e.g., by comparing L to a pre-determined number of levels in the decision tree). This hardware architecture is very high throughput and may take a same number of clock cycles to evaluate the decision tree as the decision tree depth.

Some embodiments may have one or more versions of the circuit 400. For example, a Random Forest architecture may have multiple distinct circuits (e.g., multiple copies of system 400) to compute the next node address to allow the multiple decision trees to process in parallel, where a specific decision tree is processed via one of the distinct circuits. In other implementations, a single circuit could be configured to serially process multiple decision trees. The number of processing circuits to decision trees can be varied based on the design choices of a system implementing the system 400.

Referring to FIG. 5, a diagram of a process 500 for a decision tree processing system is provided, in accordance with certain embodiments of the present disclosure. In some embodiments, the process 500 may be implemented to process a Random Forest architecture, and may be implemented, at least partially, by the system 400.

The process 500 can include training a decision tree via an external processing system, at 502. During training, a set of node values for each node of the decision tree can be obtained; these node values can include features and corresponding threshold values respective to all the nodes of a decision tree. This may take a large amount of memory and computational resources compared to the processing of the decision tree described herein. In some examples, the training may be done during manufacturing or servicing of a device.

The process 500 may then store the trained values of the multiple decision trees to a hardware memory of a processing system, at 504. For example, the trained values may be stored to memory 402 in FIG. 4 or memory 618 in FIG. 6. The training 502 and the storing 504 may be done external to a hardware device (e.g., the data storage device 602 of FIG. 6) that may implement a decision tree processing system.

A hardware processing circuit to process the decision trees and architecture may be implemented in a device, at 506. The implementation may also include software, such as firmware, to perform the operations described herein. Once a device with the processing circuit has the trained values for the decision tree nodes, the device can quickly process the decision tree architecture as described below.

During operation of the device, the processing circuit may determine a decision of a decision tree(s) based on a circuit with a feature threshold for each node or level of the decision tree(s). The process may start by retrieving node values from a memory, at 508, where the node values can include feature value(s) and a threshold value. A starting node of a decision tree may be a root node at level 0, which only has that single node; thus, when process 500 starts propagating the decision tree, at 508, the first node processed is the root node.

The process 500 may determine when a current node is the leaf node, at 510, such as by using a decision tree level counter ‘L’ that can store a value representing what depth level a current node is at within a respective decision tree. For example, when a level counter is equal to (or greater than) a maximum depth level value of a decision tree, at 510, the process 500 can know that a current node is the respective leaf node. When the level counter is less than the maximum depth level value, at 510, the process 500 can process the current node to determine a next node address, at 512. Processing the current node may be based on retrieved node values that are stored in a memory address corresponding to the current node. For example, the processing of a node may be done via circuit 400 of FIG. 4A. Once a node is processed, the value of the level counter may be increased, at 514, which indicates the determined next node address is within a next depth level of the decision tree. The maximum depth level value of a decision tree may be a pre-set number stored in a register or memory that indicates a number of levels within a respective decision tree.

When the level counter ‘L’ is equal to (or above) the maximum, the process 500 may accumulate the decisions from the decision trees, at 516, and determine a final decision based on the selected task, at 518. In some examples, the system implementing process 500 can be configured to perform a classification task, a regression task, or both wherein the system can switch between tasks. Once the final decision is determined, it may be provided as an output from the processing system, at 520, and the Random Forest computation hardware may be reset (e.g., resetting level counter ‘L’ to zero and setting the current node address to the root node address).

Referring to FIG. 6, a diagram of a system of a decision tree processing architecture, in accordance with certain embodiments of the present disclosure, is shown and generally designated 600. The system 600 may implement the methods, processes, and functions described herein; for example, the system 600 may implement the methods, processes, and functions as shown and discussed with respect to FIG. 1, FIG. 2, FIG. 3, and FIG. 4. The system 600 can include a data storage device (“DSD”) 602 that has an interface 606 that can connect to be removable from a host device 604, which can be a computer, a host bus adapter, a bus expander, a server, a telephone, a music player, another electronic device, or any combination thereof. The DSD 602 can communicate with the host device 604 via the hardware and firmware of the interface circuit 606, which may include a connector that allows the DSD 602 to be physically connected and physically disconnected from the host device 604.

The DSD 602 can include a controller 614, which can include associated memory 618 that can store firmware, data, or both. Memory 618 may be a non-volatile memory. Another memory or buffer 610 can temporarily store data from the interface 606, and may be utilized to store data during read and write operations to the data storage medium 612. In some cases, the buffer 610 can be a volatile memory, such as dynamic random access memory (DRAM) or any other type of volatile memory. Further, the DSD 602 can include a data channel 608 which can transmit data to the data storage medium 612 by encoding data during write operations and retrieve data from the data storage medium 612 by decoding data during read operations.

The controller 614 may include a processor, control circuit(s), logic circuit(s), interface circuit(s), or any combination thereof. The controller 614 may further include a decision tree processing circuit (DTC) 616 configured to process a decision tree architecture, such as described herein. The DTC 616 may include the system 400, where a portion of the memory 618 may be the decision tree memory 402. Alternatively, the DTC 616 may be a circuit separate from the controller 614. The data channel 608, DTC 616, controller 614, memory 618, buffer 610, interface 606 may be implemented as one or more integrated circuits, discrete circuits, logic circuits, firmware, or any combination thereof.

The DTC 616 may be configured to determine various analysis and predictions for the DSD 602. For example, the decision tree processing architecture may be a Random Forest architecture, which may be implemented to provide reliability characterizations and failure predictions, including providing anomaly detections and predicting data storage errors. Further examples the DTC 616 could be utilized for include predicting various channel parameters values, reading voltage values in an SSD, or determining head positional information in an HDD.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
a circuit for processing a multiple decision tree architecture, the circuit couplable to a memory and configured to:
determine a first result from processing a first node of a first decision tree of the multiple decision tree architecture based on a node value from the memory and a feature threshold; and
compute an address of a second node of the first decision tree based on the first result, a current node address, and a number of nodes in a level of the decision tree to which the current node address belongs.

2. The apparatus of claim 1 comprising the circuit further configured to process multiple nodes from different decision trees in parallel to obtain a decision from each decision tree of the multiple decision tree architecture.

3. The apparatus of claim 2 comprising the circuit further configured to determine a final decision based on whether the multiple decision tree architecture is configured to process either a classification task or a regression task, where the multiple decision tree architecture is selectable to process both a classification task and a regression task.

4. The apparatus of claim 1 further comprising the memory and an interface configured to allow storage of node specific data for the multiple decision tree architecture to be stored to the memory, the node specific data representing values for each node of the multiple decision tree architecture.

5. The apparatus of claim 4 further comprising the node specific data determined via an external data processing system and each node specific data indicates a feature and a feature threshold.

6. The apparatus of claim 1 further comprising the circuit including a memory storing a lookup table (LUT) to determine a number of nodes at each depth level of the multiple decision tree architecture, where an input to the LUT is a counter that represents a depth level of the first decision tree the circuit is actively processing.

7. The apparatus of claim 6 further comprising the circuit including a comparator circuit to determine if a value of a selected node is greater than the feature threshold.

8. The apparatus of claim 7 further comprising the circuit including an adder circuit configured to add a result of the comparator circuit, the number of nodes in a current depth level, and a current node address to compute a next node address.

9. The apparatus of claim 8 further comprising the circuit including a flip flop to store an address pointer to the next node address.

10. The apparatus of claim 1 further comprising multiple of the circuit configured to operate in parallel to process multiple decision trees simultaneously.

11. A circuit comprising:
a memory storing data representing node values of a decision tree;
a comparator circuit configured to:
receive data from the memory for a selected node of the decision tree and receive a threshold;
compare the data and the threshold to determine an output; and
an adder circuit configured to:
receive the output, a current node address, and a number of nodes at a current depth level of the decision tree; and
calculate a next node address based on the output, the current node address, and the number of nodes at the current depth level, where the next node address is a next selected node to be processed by the comparator circuit.

12. The circuit of claim 11 further comprising:
a counter circuit that indicates the current depth level of the decision tree; and
a lookup table (LUT) circuit configured to output the number of nodes at the current depth level based on a value of the counter circuit.

13. The circuit of claim 11 further comprising multiple decision trees represented via the data and a decision accumulator, where the circuit is configured to process more than one of the multiple decision trees, and the decision accumulator is configured to determine a final decision based on a decision of each of the multiple decision trees.

14. The circuit of claim 13 comprising the decision accumulator further configured to:
determine the final decision based on a classification determination;
determine the final decision based on a regression determination; and
selectively implement the classification determination and the regression determination.

15. The circuit of claim 11 further comprising an interface coupled to the memory and configured to receive the data representing node values from an external system.

16. The circuit of claim 11 further comprising the circuit is a processing circuit implementing a Random Forest architecture and the data includes a feature and feature threshold for every node in the Random Forest architecture.

17. A method comprising:
processing, via a comparator circuit, a first node of a selected level of a Random Forest architecture having a decision tree with multiple levels, the comparator circuit configured to produce a first decision;
calculating, via an adder circuit, an address of a second node at a next level of the decision tree based on the first decision, the first node’s address, and a number of nodes at the selected level;
repeating the processing and the calculating for each of the multiple levels of the decision tree before reaching a last level of the decision tree; and
obtaining an output of the decision tree based on an address of a last node in the last level that was calculated via the adder circuit.

18. The method of claim 17 further comprising processing multiple decision trees to arrive at multiple decisions, with each processed decision tree providing a respective decision, and determining a final decision based on the multiple decisions.

19. The method of claim 18 further selecting one of a classification task and a regression task to determine the final decision.

20. The method of claim 17 further comprising calculating the first decision based on a feature associated with the first node and a feature threshold, where each node has an associated feature and feature threshold that is stored in a memory.
